(19) United States
(12) Patent Application Publication
(10) Pub. No.: US 2007/0262022 A1
(43) Pub. Date: Nov. 15, 2007

(54) Separating Tray for a Distillation Column

(76) Inventors: Jurgen Mosler, Castrop-Rauxel (DE); Hans-Gunter Sparenberg, Marl (DE); Ludwig Papajewski, Marl (DE); Arndt Selbach, Marl (DE); Jorg Leistner, Dortmund (DE); Jurgen Kohn, Rheinberg (DE)

Correspondence Address: SMITH MOORE LLP, P.O. BOX 21927, GREENSBORO, NC, 27420, US

(21) Appl. No.: 11/547,109

(22) PCT Filed: Mar. 29, 2005
(86) PCT No.: PCT/EP05/03271

§ 371 Date: Jul. 6, 2007

(30) Foreign Application Priority Data
Mar. 29, 2004 (DE) 10 2004 015 714.6

(51) Int. Cl. F02M 29/04; B01D 3/00; B01D 39/00; C02F 1/28; C08G 85/00

(52) U.S. Cl. 210/659; 203/40; 210/502.1; 261/114.5; 526/62

(57) ABSTRACT

A separating tray for a column for distillation of a polymerizable material is disclosed. The separating tray comprising at least one tray plate with a plurality of openings and at least one attachment. The at least one attachment divides the plurality of openings into groups. Also, the at least one attachment defines apertures through which a fluid can flow.

This application is a national stage application under 35 U.S.C. 371 of international application No. PCT/EP2005/003271 filed Mar. 29, 2005, and claiming priority to German Application No. DE 10 2004 015 714.6 filed Mar. 29, 2004, the disclosures of which are expressly incorporated herein by reference.

The invention relates to a separating tray for a column for distillation of a polymerizable material, a process for production of a polymerizable material and the use of a polymerizable material obtainable by the above process, as well as chemical products which are based on the polymerizable material as starting material.

As polymerizable material, in general, all monomers used in radical polymerization come into consideration. Methacrylic acid, acrylic acid, styrene or α-methyl styrene fall hereunder; in one aspect, methacrylic acid or acrylic acid, in the following referred to collectively as “(meth)acrylic acid” is the polymerizable material, whereby acrylic acid is the polymerizable material in another aspect.

The standards of purity of monomers used on a large scale for polymerization are ever increasing. Ever higher purity standards are also demanded of mass plastics. This is particularly the case for polymers used in the areas of medicine or hygiene. Water or aqueous liquids-absorbing polymers, which are generally referred to as “superabsorbers,” are an important component of many products in medical and hygiene areas. Preferably, superabsorbers are used in diapers, feminine hygiene products and incontinence articles. Superabsorbers, as well as other artificial materials, are often obtained by radical polymerization of monomers comprising a double bond. Such monomers comprising a double bond, such as (meth)acrylic acid are, thus, very reactive substances, which tend to radically polymerize spontaneously under thermal stress.

Distillation is a suitable processing method which has been proven on a large scale for obtaining high purities. Because of the thermal stress on the monomer to be purified which occurs during distillation, the monomer tends, however, to undergo undesired polymerization. Here, despite addition of inhibitors, polymerization seeds form, initially mostly in dead zones through overheating and too long residence times of the monomer, which seeds grow in the course of time and lead to an ever increasing formation of undesired polymer, which leads to a shutting down of the distillation operation and to a time-consuming cleaning of the distillation apparatus, which is very costly and linked with a significant strain for man and the environment.

Distillation columns are, for example, known from WO 00/53561. In this document “Dual-Flow-Trays” are disclosed as column trays, with which the separation performance should be increased, but no measures are disclosed with which the above disadvantages should be counteracted.

The present invention overcomes the disadvantageous linked to the state of the art.

In one aspect, the present invention increases the temporal separation of maintenance intervals of distillation columns of this type, whereby, in a further embodiment, the downtimes are also significantly reduced.

According to another aspect of the present invention, as high a degree of purity as possible is achieved in the course of the distillation process by means of more than one separating tray, whereby at each separation stage, exactly reproducible and/or pre-determined chemical processes take place.

In a further aspect of the invention, a homogenous distribution of the polymerizable material in liquid or gaseous phase in a separation stage is provided, without formation of polymer deposits.

The separating tray according to the invention for a column for distillation of a polymerizable material comprises at least one tray plate with a plurality of openings and at least one attachment which divides the plurality of openings into groups, whereby with the at least one attachment, apertures which can be flowed through by a liquid are formed.

In one embodiment, the tray plate comprises metallic material, although other temperature- and acid-resistant material can also be used. The outer design of the tray plate is to be selected with respect to the distillation column, so that this can comprise, for example, round, square or similar forms. The tray plate is provided with a plurality of openings, whereby it is intended that a liquid and/or gas exchange through the tray plate is possible.

In one aspect, the openings are so large that it is possible to retain the liquid material, and a bubbling layer for heat and component exchange forms between the liquid and vapor material. The arrangement of the openings with respect to the tray plate can, in principal, be freely selected and should be aligned with the conditions on the inside of the column. It is thus, for example, possible to provide a uniform distribution of the openings over the whole tray plate, on the other hand, it can also be necessary to take a design of the tray plate which deviates herefrom. This would be, for example, the case, if edge regions of the tray plate were necessary for positioning in the column. A similar case is, for example, if the tray plate must be supported on one side because of its spatial extension and the supports would close openings of this type. In this case, no openings are provided in these regions of the tray plate.

It is now proposed that the attachment divides the plurality of openings into groups, whereby with the at least one attachment, apertures are formed which can be flowed through by a liquid. A foreground function of this attachment is to influence the movement of the liquid, which has collected on the tray plate, so that, on the one hand, a high flow speed is avoided, and on the other hand, however, that no “dead zones” are formed in which relatively long resistance times of the liquids prevail.

Particularly high flow speeds can, for example, occur if the gaseous material passing through the tray plate is not introduced completely uniformly over the cross-section of the tray plate, but, rather, in one region a particularly strong source is formed. A wave like stimulus to the liquid can then occur. In order to prevent a wave front of this type spreading over the whole tray plate and thus leading to different liquid levels on the tray plate, the attachment serves as a type of wave breaker, in that it is capable of calming waves in the upper liquid or vapor bubble layers.

Indeed, the spatially strictly delimited division of the tray plates from each other into different sectors does not necessarily guarantee an improved behavior of the liquid. Rather, by means of the division, groups of openings can be formed, which are less impinged on by the polymerizable material, so that, with respect to the sectors, different degrees of distillation can occur. For this reason, it is proposed that the liquid is indeed restricted in its freedom of movement by the attachment, but is not restricted with respect to the reachability of a plurality of openings of other sectors (in particular of all openings). This is achieved in that with the attachment, apertures which can be flowed through by a liquid are still formed. The apertures ensure that the liquid can, in one aspect, flow towards any opening of the tray plate.

The design of the aperture should also be selected here taking into account the liquid, the polymerizable material, the column or its operation. By way of example, round apertures, square apertures, slots, etc. are mentioned here. It should also be clarified that the apertures can be fully or partially limited and/or formed by the attachment. In one aspect, the apertures are arranged in lower regions, i.e. near to the tray plate. In this way it is ensured that, on the one hand, the propagation of the wave movement of the upper fluid or liquid layers is interrupted, while deeper-lying layers near to different groups of openings can communicate with each other. Attention should be paid that the apertures are designed so that as few as possible, such as no dead zones, are formed, whereby in this context, zones are meant in which the liquid has a relatively long residence time.

The liquid tends to polymerize in dead zones of this type, whereby this can lead in the long term to at least partial blocking of the openings. This has the result that the gas or liquid exchange then only occurs through a smaller number of openings, whereby the increasing gas pressure results in an additional wave stimulus of the liquid. With increasing polymerization of material, the distillation step can no longer be carried out in the desired quality, making purification and/or maintenance measures necessary. This in turn has the result that the distillation process must be interrupted and the column shut down. The separating trays must be further cleaned in a time-consuming process and then remounted. By means of the herein-proposed attachment on the tray plate, such complex measures can at least be deferred over a longer time period. Because of the fact that polymer deposits occur at significantly fewer positions, the purification can also be carried out more quickly. This means that the distillation column, on the one hand, is ready for operation over a longer time period with the desired distillation results, on the other hand, however, the purification procedure can be carried out more quickly and, thus, the down times of the distillation column are shortened.

According to a further embodiment of the separating tray, the apertures extend beyond the tray plate over a height in the range from about 1 mm to about 100 mm, such as from about 5 mm to about 50 mm, and further such as from about 10 mm to about 30 mm. This means that the apertures are only partially limited by the attachment. They are, in this case, at least also partially limited by the tray plate. It is here possible, that the apertures are only limited by the tray plate and the attachment, however, further components can also be used for limitation of the apertures. The height is selected such the liquid in the proximity of the tray plate can move or flow relatively unhindered, and, thus, it is ensured that the liquid and/or the liquid can flow uniformly towards the openings. At the same time, the liquid and/or liquid layers which are far from the tray plate are pulled through by the attachment.

According to an additional embodiment the at least one attachment comprises at least one straight bar. Such an embodiment of the attachment should then be selected if the tray plate also has straight edges, i.e. is, in particular, square or quadratic. In this way, it is possible in a simple way, to divide the openings in the tray plate in groups of almost equal number. It can also, however, be necessary that the attachment, in addition to linear bars and/or sections, comprises curved guide surfaces, which effect a flow of the appearing liquid in such way that dead zones near to the attachment are avoided. The orientation of the bar with respect to the tray plate can, in principle, be freely selected. This also means that the linear bar extends over the entire tray plate or, however, also only part-regions of the tray plates.

In this context, the attachment has at least one of the following configurations:
a) more than one attachment is provided with a bar;
b) one attachment is provided with more than one bar, such as joined together with each other.

This means that the attachment can be constructed as component with a plurality of different or same bars, on the other hand, one-piece attachments and/or connecting systems made from more than one bar, such as connected with each other by means of joining technology, are suitable for production. The bars can, in connection systems of this type, be removable or connected to each other by means of material connection. As a different criterion with these two configurations can, for example, be mentioned that the more than one attachments comprising respectively one bar are merely in contact with each other by means of the tray plate and/or other components of the column, while with a one-piece, more complex attachment and/or the bars which are connected together to form an attachment, a direct connection and/or link by means of components of the bar and/or of the attachment is formed itself. While alternative (a) enables a very flexible arrangement of the bars with respect to each other, the configuration (b) has the advantage that this can be mounted simply and with little time expenditure. In view of these points, it can be advantageous that in a central region, the complex attachment formed from more than one bar is used, while in the edge areas, depending on the form and/or design of the attachment or of the column, additional individual bars are positioned for completion of the first attachment. In this way, it can be ensured that, for example, groups of openings are formed with substantially the same number.

According to another embodiment of the invention, the at least one bar has a length, whereby the plurality of apertures is limited at least partially by at least one of the following elements:
(a) at least one rod, which is part of the bar;
(b) at least one spacer, which is a separate part.

whereby these elements comprise a width and the sum of the widths of the elements is less than about 80%, in another aspect less than about 60%, in a further aspect less than about 40% of the length of the bar. Besides the possibility of fixing the attachment mentioned with a certain distance with respect to the tray plate at the column and/or the container, in this aspect of the invention, an easily mountable construction unit with the tray plate is proposed. This means that the tray plate with the at least one attachment can be incorporated together into the column. This has the result that the at least one attachment should be fixed onto the tray plate itself. It is now here proposed to effect this by means of rods or spacers or both elements.

The rods, which are themselves parts of the bar, can, for example, be produced by form-giving processes, such as, for example, pouring, milling or the like. It follows therefrom that the rods are formed from the same material as the bar itself. In one aspect, the rods and the bar itself are built from different materials, whereby, for example, first the bar is produced in one piece and then the rods are connected to the bar using a joining technology manufacturing process (removable or non-removable).

Alternatively or in combination thereto, separate spacers can be positioned on the tray plate, which themselves comprise means for fixing of the bar. This has the advantage that the bars can, for example, all be formed substantially square, whereby by means of respective different designs of the spacer, the desired heights of the apertures can be generated. This results, on the one hand, in a cost-effective production of the bars and a simple process-dependent adaptation of the apertures.

The rods and/or spacers serve in particular to stabilize and/or position the bar in relation to the tray plate. That means that the bar is arranged, for example, in the edge regions of the tray plate by means of respectively a rod and/or a spacer, while in the central regions, depending on the length of the bar, an additional element (rod and/or spacer) is provided. These then extend, in one aspect, to the tray plate; the rods can, however, also be designed shorter, in order to generate the certain profile of the apertures, which has, for example, advantageous influences with respect to the flow behavior of the liquid.

As already mentioned, in one embodiment of the present invention, the sum of the widths of the rods and/or spacers is less than about 8%, such as less than about 60%, and further such as less than about 40% of the length of the bar. In this embodiment, as few as possible, and relatively slim elements for stabilization of the bar should be used. This ensures that the flow of the liquid in the proximity of the tray plate can propagate relatively unhindered. The bars and/or spacers can be equipped with a flow-technical favorable profile, in particular to form suitable edges for flowing around (e.g. round cross-section forms). Corresponding to the flow speed appearing, it can be necessary to provide an increased number of rods and/or spacers, but to design these relatively thin, while in other applications, respectively one rod and/or one spacer in the edge region of the tray plate is sufficient, but the central region is free from rods and/or spacers. By means of clarification, it should be maintained here that the length of the bar describes the longest extension in a direction and the width of the rods and/or of the spacers should be determined in the same direction, whereby the widths and the lengths can be arranged in one level or in levels which are parallel to each other.

According to yet a further embodiment, the separating tray is designed such that the at least one attachment forms sectors of the tray plate with respectively one group of openings, whereby the sectors comprise an area that can be in the range from about 1.2 m² to about 0.3 m², in a further aspect from about 1.0 m² to about 0.5 m², and in yet an additional aspect from about 0.8 m² to about 0.6 m². In principle, separating trays of this type can be formed with a one-piece or a multi-piece tray plate and from more than one individual tray plate, whereby it is, in principle, ensured that an unevenness of the tray plate of less than about 3 mm/m, in another aspect less than about 2 mm/m, and in yet another aspect less than about 1 mm/m is achieved. A round tray plate can have, in total, a diameter in the range from about 2 m to about 7 m, such as from about 3 m and about 5 m. In this way, the openings in the tray plate can have a diameter of from about 15 mm to about 40 mm, such as from about 20 mm to about 30 mm. It is further proposed that the separating tray has a cover plate, whereby this can be arranged at a separation in the range from about 60 mm to about 200 mm, in an additional aspect from about 80 mm to about 150 mm, and in yet a further aspect from about 100 mm to about 120 mm from the tray plate, and, in particular, likewise comprises a plurality of openings.

The cover plate has a plurality of different functions. Thus, for example, one function can be seen as being that in this way, it is hindered or at least substantially reduced that the rising vapor-form material pulls with it parts of the liquid material accumulated on the tray plate. In this way, the separated liquid which accumulates at the cover plate when the vapor-form material rises, is uniformly distributed again and conducted back down to the tray plate. In order to strengthen this effect, the cover plate comprises openings, which do not run parallel to the preferred flow direction of the vapor-form material, but, rather, diagonally thereto, e.g. within an angle between about 10° and about 50°. In this way, a more intensive contact of the material with the cover plate is enabled. These advantageous effects lead, individually and particularly in combination with each other, to an increase in the efficiency of the separating tray. Furthermore, the cover plate can favor at least the material exchange or the heat exchange, whereby a further improvement of the separation performance is created. At the same time, a uniform flowing away of the vapor-form material from the separating tray through which it has just passed to the next is enabled. Accordingly, the cover plate functions like a flow rectifier, which ensures a uniform flow to the following separating tray. Accordingly, the cover plate can be designed exactly like such a flow rectifier, with a grating structure or honeycomb structure or a hole plate similar to the tray plate. In the design of the cover plate according to a honeycomb structure of more than one structured plate layer, which form channels which can be flown through, the cover plate has a thickness of at least about 50 mm, in an additional aspect at least about 100 mm, and in yet a further aspect about 150 mm, however, generally not greater than about 300 mm.

According to a further embodiment of the separating tray, this comprises a holder, which comprises at least one solid carrier, which is in contact with the side of the tray plate which faces away from the at least one attachment, in one aspect over at least a dimension in the range from about 200 mm to about 1000 mm, in an additional aspect from about 350 mm to about 800 mm, and in yet a further aspect from about 400 mm to about 600 mm. It also possible that the carriers are at least partially directly substantially perpendicular to each other and are optionally connected to each other with connection elements, whereby the carriers can be provided in different directions with different dimensions to each other.

The holder mentioned can take over a plurality of functions, whereby, here, in particular, at least one of the following functions stands in the foreground: The fixing of the separating tray in relation to the column and/or further separating trays, or the increase of the stiffness of the separating tray. If this holder serves for fixing, these can be arranged such that it extends to the edge region of the separating tray, so that it can be connected to components of adjacent constituents (e.g. of the column of further separating trays). The function relating to the increase of the stiffness of the separating tray then comes, in particular, into the foreground if the separating tray or all tray plates together spans an area of more than about 10 m², in one aspect more than about 13 m², and in an additional aspect more than about 15 m². With increasing sides of the separating tray, it is ensured by use of the holders that the tray plate is, nonetheless, even, and that in central regions, a sinking of the tray plate in relation to the edge regions is avoided. Unevennesses of the tray plate of this type would have the result that in proximity to the tray plate, border layers would be formed, which have a reduced tendency to flow and thus tend to polymerize. Since these unevennesses would have relatively large areas, a very large numbers of openings could be blocked by these polymerization deposits. These processes which restrict the functional capability of the distillation column can be avoided by the use of the here-proposed holders.

In this respect, it should be mentioned that a solid carrier may be a carrier without hollow spaces in its interior, i.e. spaces which are completely surrounded by the material of the carrier, whereby inclusions or cavities for production are excepted. In this aspect, the carriers are also not designed such that stiff, yet hollow space-forming profiles are provided. Although it is, in principal, possible, to produce such holders from U-profiles with relatively thin walls, here, relatively thick-walled, solid carriers are proposed in this aspect. The carriers are affixed to the side of the tray plate which is facing away from the liquid level. Accordingly, they do not serve for direct flow influencing, but only optionally as flowing away edges or services for liquid or liquid which has passed through the openings of the tray plates or which is condensed at the holder or at the separating plate.

According to a further embodiment, the at least one carrier has, near the tray plate, at least one recess with an extension, whereby the sum of the extensions lies at least in the range from about 80% to about 30%, in an additional aspect from about 70% to about 40%, and in yet another aspect from about 60% to about 55% of the dimension 46. The recesses have inter alia the function of enabling a flowing through with the vapor-form material, and optionally of representing tear edges for liquid flows rippling towards the carrier. The greater the surface of such a carrier, the more the liquid which has passed through the openings can collect there. Thus, the risk would also exist that border layers are formed, in which polymerization could rapidly occur. For this reason, it is here proposed that, already after short flow paths, edges are formed which prevent a further flow along the carrier as a result of gravity. These edges have the result that, for example, drops form, which separate from the carrier and continue to move freely in the direction of the lower floor of the distillation column or separating trays lying therebetween. In order to ensure that, on the one hand, such advantageous dropping away of the liquid is ensured, but on the other hand, also, the stiffness-increasing property of the carrier is ensured, it is proposed that the sum of the dimensions lies in the above-mentioned percentage region of the dimension. It is also noted in this context that the dimension should be determined in the direction of the longest extension of a carrier, whereby the extension of the recesses should be determined in the same direction, so that extension and dimension lie in the same level of the carrier or in levels of the carrier which are parallel to each other.

According to a further embodiment, the carrier is designed T-shaped, whereby the at least one recess is arranged in the carrier part which is substantially perpendicular to the tray plate. The T-shaped embodiment has the advantage that with the upper carrier part which lies substantially parallel to the tray plate, a contact area is formed with respect to the tray plate, which ensures an even and relatively large surface support. In this way, sufficient possibilities for connecting to the tray plate are given. In this respect, it is further advantageous that the tray plate comprises no openings in the region of the installation with the carrier. Furthermore, this carrier part lying substantially parallel to the tray plate has the advantage that upon flowing away of the liquid, the first tear edge is formed already after a short path, namely, exactly there where the upper carrier part stops. The carrier part arranged substantially perpendicular to the tray plate is here positioned so far from this edge that an accumulation of liquid as a result of the surface tension in the region of the meeting of the upper and lower carrier part is avoided.

It should be taken into account that the gaseous, polymerizable material can condense at the lower side of the carrier part lying substantially parallel to the tray plate, and now the possibility exists that this liquid flows away at the carrier part lying substantially perpendicular to the tray plate. For this reason, the arrangement of at least one recess is proposed. Furthermore, the provision of such recesses is advantageous because in this way, material is economized and thus the production costs, the component weight, and also the human strength for mounting of such separating trays can be considerably reduced. Taking these points into account, the recesses can also be designed according to the criteria of light building methods, as are already often used. The points of view of the light construction methods can be further strengthened by appropriate selection of material.

According to a further embodiment of the separating tray, it is proposed that the at least one T-shaped carrier has a foot arranged parallel to the tray plate, with a dimension in the range from about 50 mm to about 100 mm, in an additional aspect from about 60 mm to about 90 mm, and in yet a further aspect from about 70 mm to about 80 mm, whereby the at least one recess is arranged at a distance of less than about 10 mm from, in particular directly at the foot, and one aspect has a width in the range from about 40 mm to about 120 mm, in an additional aspect from about 60 mm to about 100 mm, and in yet a further aspect from about 75 mm to about 85 mm. For the production of such a carrier, it is also possible to connect more than one individual part removably (e.g. with connecting elements) or non-removably (e.g. by means of weld-connections) with each other. The dimensioning of the T-shaped carrier occurs substantially taking into account two interests. On the one hand, care should be taken that the carrier provides sufficiently the desired stiffness of the separating tray; on the other hand, it should be taken into account that the head capacity of such a carrier can play an important role with respect to the operation of the distillation column. This means that with temperature variations inside the column, overly large temperature differences between the gas flowing past and the carrier must not occur, since this results in an increased risk of condensation and/or polymerization of the material.

It is further proposed that the at least one carrier and the least one attachment are arranged perpendicular to each other. This means that the carrier and the at least one attachment form a type of framework which results in stabilization of the tray plate in a level. This is increasingly true as the at least one attachment comprises direct connection regions with the tray plate (also in the central region). Such a stiffening of the tray plate by means of such a framework system has the result that the above-described regions concerning the dimension and/or the width of the T-shaped carrier can be designed more slimly, such as in regions of the lower half or the lower third of the value regions given.

It is further proposed that the separating tray is provided at least partially with a coating, which has an improved glide property for liquids compared to steel. It should here be mentioned that a coating of this type extends at least partially over one of the following components: the tray plate, the holder, the attachment, the spacer. In principle, the coating can extend, starting from the surface of the components, over a few micrometers up to a few millimeters (in one aspect from about 50 μm to about 1000 μm, in another aspect from about 100 μm to about 800 μm, and in yet another aspect from about 200 μm to about 400 μm). As coating, in particular a polyfluorohydrocarbon, such as Teflon®, polyaniline varnishes or coatings with a metal ion-free surface (e.g. glass) or also mixtures of at least two of these types of coatings are proposed. If glass is used as coating agent, it can be particular technical glass, which has been obtained from cooled melts of silicon dioxide (SiO₂), calcium oxide (CaO), sodium oxide (Na₂O), optionally with greater amounts of boron trioxide (B₂O₃), aluminium oxide (Al₂O₃), lead oxide (PbO), magnesium oxide (MgO), barium oxide (BaO) or potassium oxide (K₂O). In one aspect, this technical glass consists to at least about 50 wt. %, in another aspect to at least 65 wt. %, and in yet another aspect to at least 80 wt. % of SiO₂.

It is, in principle, also possible to produce the separating tray at least partially from a non-metallic material, so that a separate coating of the above-mentioned type is not required. In addition to the above-mentioned materials, plastics or a composite (e.g. from Teflon® and plastic) can be used for production of at least one component or of the entire separating tray. The provision of the tray plate from Teflon® or plastic is particularly advantageous.

It should also be mentioned in addition that, in one aspect, the container comprises a plurality of separating trays and at least one spray unit is provided, with which a lower side of at least one separating tray can be sprayed with the polymerizable material. A spray unit of this type removes effectively partial amounts of the polymerizable material adhering to the lower side of the separating tray, so that a polymerization at these positions can be avoided. In this embodiment, the lowest separating tray of the column is positioned within reach of such a spray unit. It is here advantageous that the spray unit is supplied with liquid polymerizable material from the collecting reservoir of the container and this is sprayed uniformly distributed on the lower side of the separating tray. In one aspect, the spray unit comprises a plurality of nozzles, which form uniformly distributed spray regions over the cross-section of the separating tray. In another aspect, the spray unit is operated with high pressure, e.g. in the range from about 2 to about 5 bar, and in an additional aspect at about 3 bar. In yet another aspect, the spray unit is positioned at a small distance to the lower side of the separating tray, such as at most about 1 meter or about 50 cm, whereby this can be varied taking into account the spray region and/or the number of nozzles. The above-described spray unit can be used in combination with a separating tray of the type described here according to the invention. Further details can be found in the figures description.

The invention further relates to a process for purification of a polymerizable material, whereby the polymerizable material in the column according to the invention is introduced as a liquid material through the inlet and in the inner region is transferred to an at least partially vapor or gaseous state. In one aspect, the vapor or gaseous state flows with a isotropic density against a first separating tray arranged above the inlet, whereby within a level between the inlet and the first separating tray the maximum deviation from an average volume of the isotropic density is at most about 50%. It is particularly advantageous if the maximum deviation is at most about 10%, such as only about 5%. The level here lies relatively tight and parallel to the first separating tray, in order to ensure a relatively compact construction of the column. The level lies in one aspect at most about 100 mm below the first separating tray, the distance of the level from the first separating tray can, however, also be at most about 50 mm or even only at most about 10 mm.

A particularly even distillation with a very low tendency to polymerize in the column is given if the at least one separating tray is designed such that the isotropic density is also reached in the liquid phase of the polymerizable material. This can be achieved particularly by the use of a so-called “Dual-Flow-Tray.” In this way, any optional flow of the vapor or gaseous state over the separating tray can be implemented with the proposed isotropic density, whereby the maximum deviation occurring is further clearly reduced.

In general, as polymerizable material, according to the invention, all chemical compounds which tend to polymerize and are known to the skilled person come into consideration. In one embodiment of the invention, polymerizable materials are monomers used in the production of mass plastics, such as, styrene, α-methyl styrene, methylmethacrylate, butylacrylate and the like. In one aspect, the polymerizable material used in the process according to the invention is (meth)acrylic acid. The term “(meth)acrylic acid” here stands both for the compound with the nomenclature name “acrylic acid” and for the compound with the nomenclature name “methacrylic acid,” whereby of the two, acrylic acid is the polymerizable material in one aspect of the present invention. In another aspect, in the process according to the invention, in the inner region an absolute pressure prevails. This pressure lies in the range from about 50 to about 400 hPa (hectopascal) in one aspect, from about 100 to about 300 hPa in another aspect, and from about 150 to about 250 hPa in yet a further aspect in the inner region of the column (whereby 1 hPa=1 mbar=10² Newton/meter² [N/m²]=10² Pa).

In an additional aspect, in the process according to the invention, the liquid material is superheated. In this context, the temperature of the main component of the liquid material, mostly the polymerizable material, lies at least about 1° C., in another aspect about 5° C., and in yet another aspect at least about 10° C. above the boiling temperature of the pure head component of the liquid material.

The invention further relates to a process for production of a polymerizable material, whereby the polymerizable material is synthesized from at least one reagent in a reactor and then subjected to a process according to the invention for purification. The synthesis of the polymerizable material is not limited to a particular process. Rather, all processes known to the skilled person can be considered. In the synthesis of acrylic acid, in one aspect at least two-step gas phase oxidation reaction, in which in a first step, by catalytic oxidation of propylene, acrolein is obtained and in a further step, acrylic acid is obtained as gas phase. This gas phase is then brought into contact, in a quench unit, with a liquid, such as water or an organic compound which boils higher than water or a mixture thereof and indirectly or directly subjected to the process according to the invention for purification. Details concerning the production and further purification processes for acrylic acid can be taken from WO 02/055469 and the reference cited therein.

In addition, the invention relates to the use of an inlet according to the invention for distillation of a polymerizable material.

Furthermore, the invention relates to a polymerizable material obtainable according to a process according to the invention, whereby the polymerizable material can be acrylic acid or methacrylic acid, such as acrylic acid.

In addition, the invention relates to the use of a polymerizable material according to the invention, such as acrylic acid, as starting material in formed masses, fibers, sheets, absorbent polymers, in polymers for leather and textile processing, in polymers for water treatment or in polymers for soap production.

The invention also relates to formed masses, fibers, sheets, absorbent polymers, polymers for leather and textile processing, polymers for water treatment or polymers for soap production, at least partially based on a polymerizable material according to the invention, such as based on acrylic acid.

The invention is now more closely illustrated by means of the figures, whereby the example embodiments depicted show various aspects of the invention or of the incorporation of the invention into the known field of distillation columns illustrated. It should be mentioned that the invention is not restricted to the depicted example embodiments. In addition, independent thereof, further particulars are also described concerning the technical area of distillation columns.

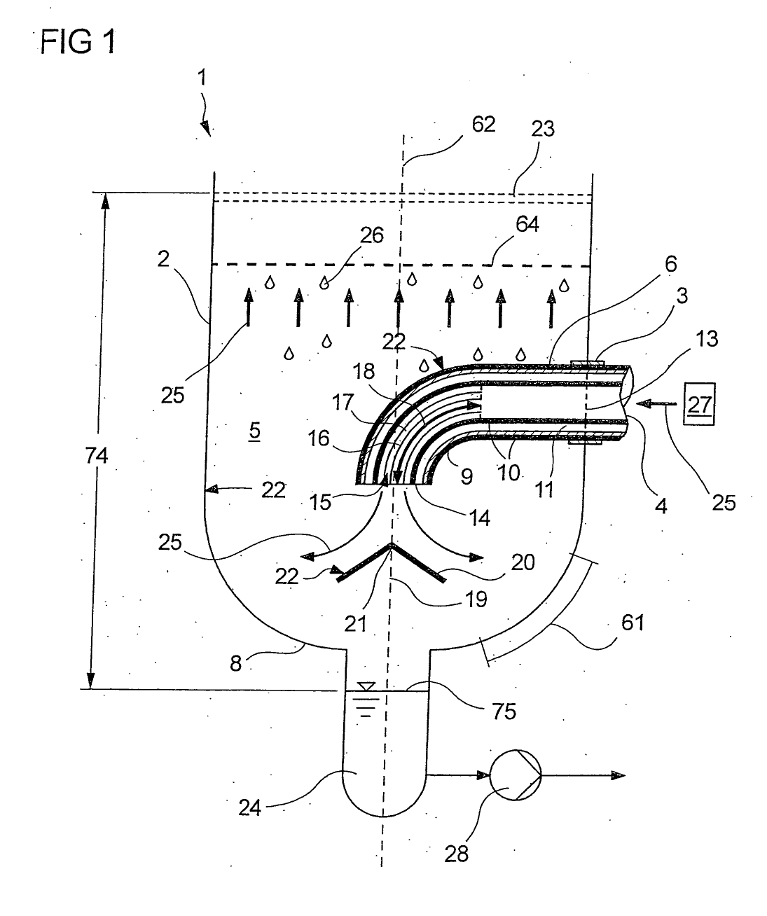

FIG. 1 shows schematically and in perspective, the construction of a column with an inlet for a polymerizable material;

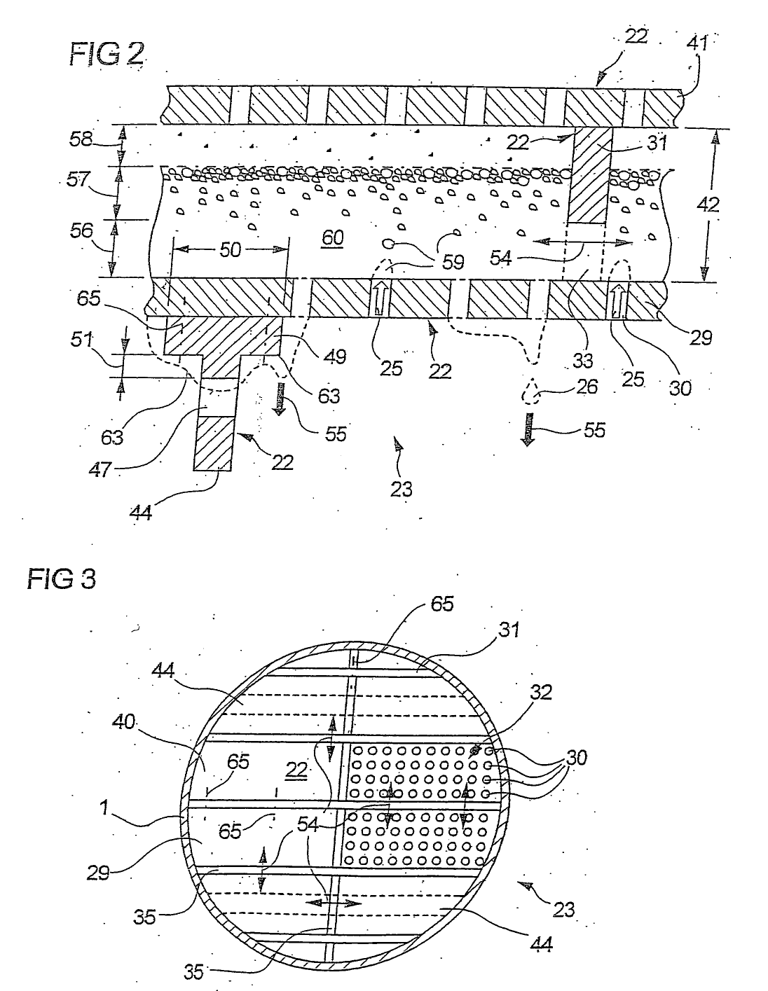

FIG. 2 shows schematically, a sectional view through a design of a separating tray;

FIG. 3 shows a schematic view of a further embodiment of a separating tray;

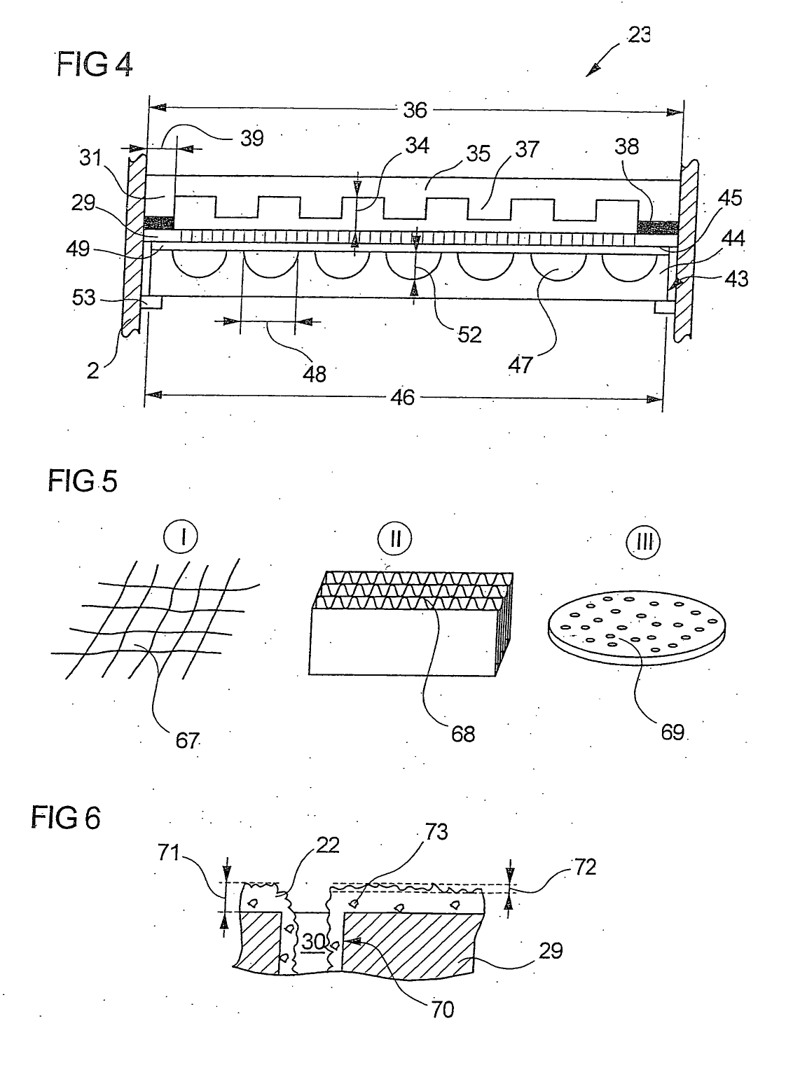

FIG. 4 shows a further schematic view of a further embodiment of the separating tray in section;

FIG. 5 shows a simplified schematic representation of different embodiments of a flow rectifier;

FIG. 6 shows a schematic detailed view of an embodiment of a coated tray plate of a separating tray;

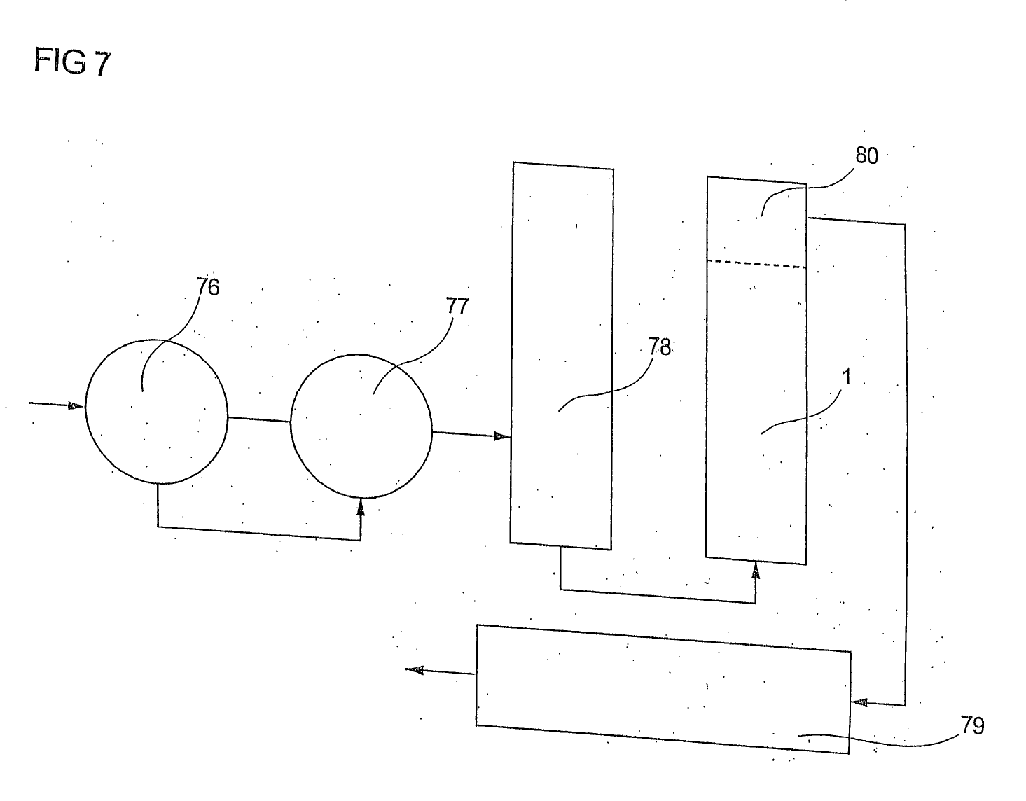

FIG. 7 shows a schematic representation of an installation for production of acrylic acid;

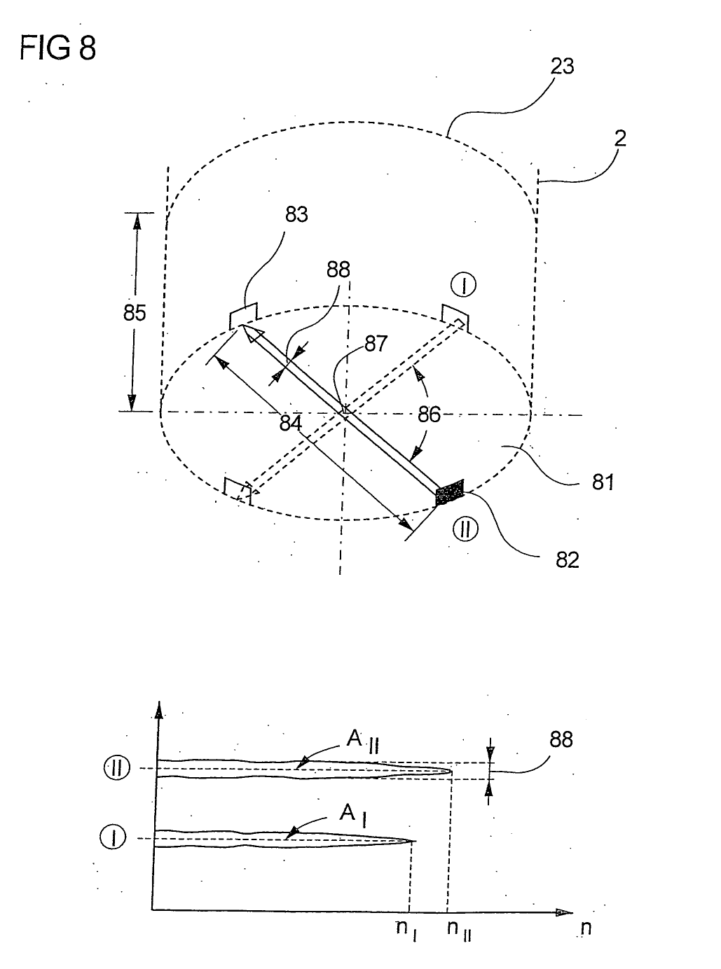

FIG. 8 shows schematically, the construction of a trial arrangement for determination of the density distribution;

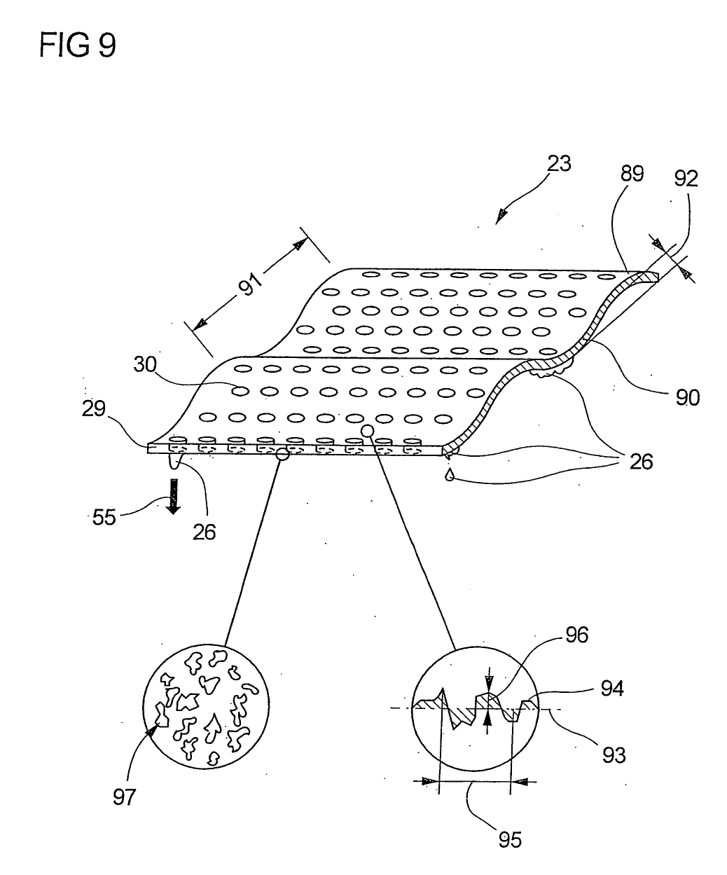

FIG. 9 shows schematically and in perspective, a waved tray plate of a separating tray;

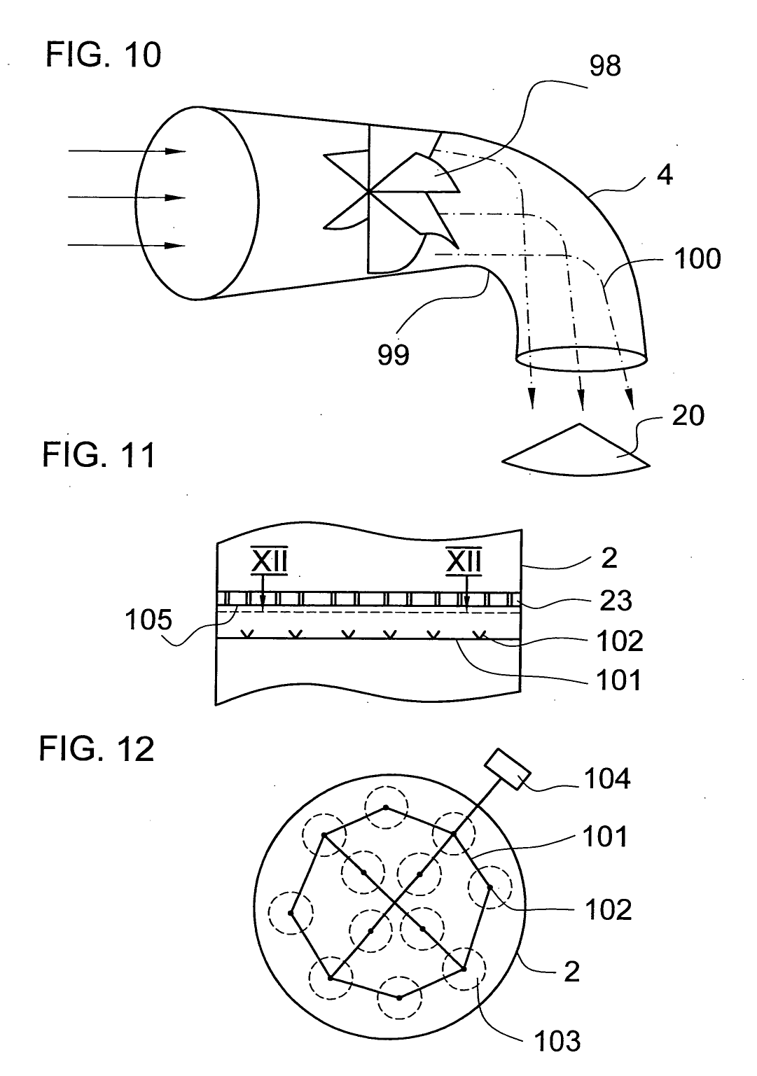

FIG. 10 shows schematically and in perspective, a further embodiment of the inlet with a flow mixer;

FIG. 11 shows a partial section of a container with a spray unit in cross-section; and

FIG. 12 shows the top view of the spray unit shown in FIG. 11.

FIG. 1 shows schematically and in a section view a column 1 for distillation of polymerizable material, whereby this comprises a container 2 with a lower floor 8 as an inlet 4 for the polymerizable material. The inlet 4 leads into an inner region 5 of the container 2. As more closely detailed in the following, column 1 comprises various means for uniform distribution of the material in the container 2.

In order to be able, in principal, to understand the flow course of the polymerizable material, its path through column 1 is first described. Generally, the polymerizable material is initially present as liquid and is transformed and/or superheated into a vapor and/or gaseous state by means of a heater 27. Starting from heater 27, the material flows in flow direction 25 through an inlet 4 into the inner region 5 of the container 2. At entry, or a short time after entry into the inner region 5, the partially liquid, partially vapor or gaseous material flows further in flow direction 25 (here depicted vertically upwards by means of the arrows) towards a separating tray 23, in which a first distillation stage is carried out. Condensed components of the material in the form of drops fall back in the direction opposed to flow direction 25 onto the inlet 4 or onto the lower floor 8 of container 2. At the lowest position, container 2 comprises a collecting reservoir 24, in which the condensation collects. This collecting reservoir is connected to a pump 28, which effects the transport away of the condensation in the collecting reservoir 24 from column 1.

Upon closer observation of inlet 4, it can first be seen that this has an entry orifice 13 and 30 an exit orifice 14, whereby, here, the exit orifice 14 is arranged closer and substantially parallel to the lower floor 8 of container 2. The inlet 4 is depicted as separate component, which extends through an attachment 3 through container 2 into the inner region 5. The inlet 4 comprises straight and bent partial regions, whereby these are here designed so that the exit orifice 14 is positioned with its central axis 19 central to the central axis 62 of container 2. On the inside of the inlet 4, a flow influencer 15 is arranged over a section 18 towards the exit orifice 14. The flow influencer 15 comprises a plurality of baffles 16, which ensure channels 17 for equilibration of the flow of the polymerizable material on the inside of the inlet 4. Central to the central axis 19 or to the central axis 62, a conical flow distributor 20 is arranged such that its tip 21 is closest to the exit orifice 14. As depicted in FIG. 1 by means of the arrow (flow direction 25), the arrangement of the flow distributor 20 in the inner region 5 of the container 2 results in a deviation of the inflowing material, whereby in support, the container 8 is additionally designed such that the guiding surfaces 61 support the uniform distribution of the material in the container 2. Furthermore, with the depicted arrangement of the flow distributor 20, the advantage is achieved that the inflowing material is not mixed directly with the condensation stored in the collecting reservoir 24, so that the flow distributor 20 also has a protective function here.

With respect to inlet 4, it should be noted that this is provided with a plurality of means for thermal insulation with respect to the inner region 5, whereby these are arranged in partial area 9, which extends over the total outer area 6 of inlet 4, which is in contact with the inner area 5 of container 2. The inlet 4 is formed as a double-walled pipe, so that it comprises two jackets 10, which are arranged co-axial to each other. Between the two jackets 10 a thermally insulated layer 11 is present as vacuum, whereby the inner surfaces 12 of the jacket 10 are mirrored.

In order to prevent that in particular liquid components of the polymerizable material collect and/or remain adhered to the surfaces limiting the inner space 5, the whole outer surface 6 of the inlet 4, the whole jacket surface and/or tip 21 of the flow distributor 22 and also the inner wall of the container 2 are provided with the coating 22, which has an improved glide property for liquids compared to steel.

FIG. 2 shows schematically and in a partial section a separating tray 23, which comprises a cover plate 41, an attachment 31, a tray plate 29 and a carrier 44. The liquid 60 is arranged between the cover plate 41 and the tray plate 29. The gaseous, polymerizable material comes into contact in flow direction 25 with the liquid 60 through the opening 30 of the tray plate 29, whereby different border layers form between the tray plate 29 and the cover plate 41. In this way, a liquid layer 36 can be recognized, which is substantially free from bubbles 59. Above this, a vapor bubble layer 57 and/or a type of foam layer is arranged. This represents practically a type of border layer between the liquid 60 and the gaseous volume. Between the cover plate 41 and this vapor bubble layer 57, a droplet layer 58 is further arranged, whereby this is substantially characterized by a gaseous state of the material to be distilled, which is pervaded by liquid drops 26 coming from cover plate 41. While the gaseous material moves from below to above in flow direction 25 (as depicted in the picture) the liquid 60 follows gravity 55 and falls in the opposite direction (counter current flow principal) towards the lower floor 8 (not depicted).

It should further be mentioned at this point that the cover plate 41 is not necessarily constructed in one part but can also be in more than one part. In one aspect, the cover plate 41 comprises a plurality of structured plates and/or plastic elements, which are piled into packages and between which (such as not linear) flow passages form. The plates and/or plastic elements may be arranged substantially parallel to the direction of gravity, in one aspect at a distance 42 from the tray plate 29 in the range from about 100 to about 200 mm. The plates and/or plastic elements may also be provided in such a way that a thickness of the cover plate 41 or of the package of about 100 to about 200 mm results.

The tray plate 29 comprises a plurality of openings 30, which are divided with assistance from the attachment 31 into more than one group 32 (see FIG. 3). The attachment 31 is, however, designed such that apertures 33 through which fluid and/or liquid 60 can flow and which ensure, in the direction of arrow 54 (i.e. substantially parallel to tray plate 29 and/or substantially perpendicular to flow direction 25 of the material), a liquid exchange from openings 30 arranged adjacent to each other. Attachment 31 is here provided with a coating 22, which has an improved glide property for liquids compared to steel. At the same time, the attachment 31 functions as separation limiter and/or supporting wall with respect to the two plates 29 and 41. In this way, it is ensured that the cover plate 41 is arranged at a pre-determined separation 42 from the tray plate 29, such as parallel to tray plate 29. Taking into account the size and/or height 34 of the apertures 33, it should be recognized that this is formed substantially somewhat smaller than the liquid layer 56, so that in upper-lying regions of the liquid layer 56 which are arranged near to the vapor bubble layer 57, the flow is hindered, while near to the tray plate 29 in the direction of the arrow 54 relatively unhindered liquid movements are enabled. The cover plate 41 can also be formed as flow rectifier 64, in particular as honeycomb structure 68 with a plurality of channels through which a liquid can flow.

On the side 45 facing away from attachment 31, a carrier 44 is provided as holder. The carrier 44 is formed T-shaped and comprises a foot 49 arranged substantially parallel to tray plate 29, with an imaginary dimension 50 as well as a lower carrier part which is substantially perpendicular hereto. Recesses 47 are provided in the carrier part of the T-shaped carrier 44 substantially perpendicular to the tray plate 29. In the embodiment example depicted, the recesses 47 are arranged at a separation 51 of less than about 3 mm. In this way, a plurality of tear edges 63 is formed which have the result that draining liquid (depicted as dashed line) forms drops 26 and comes away from the surface in the direction of gravity 55. In support of this effect, both the tray plate 29 and the carrier 44 are provided with a coating 22, such as Teflon®.

FIG. 3 shows, schematically and in a top view, the further embodiment of a separating tray 23 according to the invention. As can be seen here, the depicted separating tray 23 spans the total inner area 5 of the column 1 or of the container 2. It is, however, also possible that a plurality of separating trays 23 of this type, such as square, are put together in a unified platform, which then spans the total inner area 5 of the column 1. The round embodiment shown here of the separating tray 23 comprises a plurality of openings 30, whereby these are divided by attachment 31 into several groups 32. The attachment 31 comprises a plurality of bars 35, which are connected in regular arrangement with each other by means of joining technology. The thus-designed attachment 31 forms sectors 40 of the tray plate 29 with respectively one group 32 of openings 30. The attachment 31 is designed such that, in the direction of the arrow 54, an exchange of liquid or liquid from neighbouring sectors 40 is still ensured. With dashed lines are shown in addition the carriers 44 on the lower side 45 of the tray plate 29 provided with a coating 22. These are here connected directly to column 1 and serve inter alia to increase the stability of tray plate 29.

FIG. 4 shows a further section view for illustration of a variant of the separating tray 23 according to the invention. As can be seen from FIG. 4, the holder 43 of the separating tray 23 is provided with a carrier 44, which is connected by means of projections 53 to the container 2 of column 1, so that a substantially horizontal positioning of separating tray 23 in the inner region 5 of column 1 is ensured. The projections 53 are here shown simplified. In fact, a plurality of adjustment possibilities can be provided which enable an exact horizontal positioning of the separating tray 23 in the inner space 5. The carrier 44 shown has a dimension 46 and is T-shaped. Besides the carrier part positioned substantially perpendicular to tray plate 29, the carrier 44 comprises a foot 49 which serves as support plate for the tray plate 29. Directly at this foot 49 is attached, in the perpendicular carrier part, a plurality of recesses 47, whereby these are here formed as semi-circles. The semi-circular design 47 is not compulsory, but has advantages with respect to stiffness aspects because of its rounded contours. These recesses 47 can be described by an extension 48, which should be determined substantially parallel to tray plate 29 and/or to foot 49. Perpendicular hereto, the recesses 47 comprise respectively a width 52. In one aspect of the invention, the recesses 47 are so designed that the sum of the extensions 48 lies at least in the range from about 80% to about 30%, in another aspect from about 70% to about 40%, and in yet an additional aspect from about 60% to about 65% of the dimension 46.

In FIG. 4, above the tray plate 29 is depicted an attachment 31 in the form of bar 35. The bar 35 is fixed by means of spacer 38 in the edge area of the tray plate 29 near to the container 2. By the simple provision of such spacer 38, a gap would already be generated between the bar 35 and the tray plate 29, which could already result in the here-described advantageous influencing of the fluid flow. In FIG. 4, for illustration, however, a further particular embodiment of the bar 35 with individual bars 37 is depicted. The bars 37 and/or the spacer 38 have a breadth 39, whereby the sum of the breadth 39 is considerable smaller than the length 36 of the bar 35 (for example less than about 50%). With respect to the above-mentioned percentages, in one aspect only the spacers 38 and/or bars 37 with their width 39 go in, which are in direct contact with tray plate 29, i.e. actually hinder the flow over the total liquid layer. With assistance from the bars 37 and/or the spacers 38, apertures 33 are accordingly formed, which in another aspect, starting from the flow plate 29, have a height 34 in a range from about 1 mm to about 100 mm, in a further aspect from about 5 mm to about 50 mm, and in yet an additional aspect from about 10 mm to about 30 mm.

FIG. 5 shows schematically different embodiments of flow rectifiers 64, which serve to improve the flow of the vaporous polymerizable material towards a separating tray 23. In principal, it should first be mentioned that such a flow rectifier 64 fulfills the function of achieving a uniform flow of the polymerizable material towards the at least one separating tray 23. Uniform in this sense means that in one aspect at least one of the factors flow speed and flow direction over the cross-section of the inner region of the column 1 near to separating tray 23 only has a deviation in the range of less than about 20%, in another aspect less than about 10%, and in yet a further embodiment less than about 5%. This means, for example, that with a given flow speed of the vapor or gaseous state material of about 2 m/s to about 5 m/s [meter per second] at most deviations upstream of the flow rectifier of about 1 m/s [about 50% of about 2 m/s] to about 7.5 m/s [about 150% of about 5 m/s] are present. With respect to flow direction 25 is meant that starting from a flow impinging perpendicularly on the at least one separating tray 23 (perpendicular flow direction towards) a tolerance about this perpendicular flow direction towards of at most about 180°, in another aspect about 120°, and in yet a further aspect about 72°, in an additional aspect only about 45°, and in yet an additional aspect at most about 20° is present. In respect of this, a symmetrical arrangement of the tolerances in respect of the perpendicular flow direction towards is assumed.

The flow rectifier 64 is can be designed flat and positioned substantially parallel to the at least one separating tray 23 and/or fixed in the inner region 5 of column 1. The flow rectifier 64 is in one aspect at least partially made from a corrosion- and high temperature-resistant material and can be flowed through by a fluid. For this, in particular, openings are provided which, on the one hand, influence a flow profile, such as with respect to speed and/or direction, on the other hand, however, prevent a blocking or closing of the openings. The flow rectifier 54 extends in one aspect over the total inner region 5 of the column 1.

This flow rectifier 64 comprises accordingly at least one of the following elements: At least one grating structure 67, at least one honeycomb structure 68, at least one hole plate 69 or a so-called package. These elements can be connected directly or indirectly to the separating tray 23, in particular be a part of the separating tray 23. The grating structure 67 comprises more than one longitudinal, fiber-like structure, which are connected with each other chaotically or like a web. Suitable as such longitudinal, fiber-like structures are, for example, coated metal wires. The honeycomb structures 68 can be produced in one piece or from a plurality of components. The embodiment shown here comprises more than one smooth and structured plate layer which are connected to form a honeycomb structure 68. The hole plate 69 can, besides the depicted round embodiment, also be designed square, oval, with plural corners or in another way. The number of holes in one embodiment is more than about 30% of the total area of the hole plate 69.

FIG. 6 shows a detail of an embodiment of a separating tray 23 comprising a tray plate 29 with the coating 22 which has a reduced adhesive property for liquids compared to steel. It can be seen from the depiction that the coating 22 can be described by means of the parameters layer thickness 71, surface roughness 72 and porosity 73. The coating 22, which in one aspect comprises polytetrafluoroethylene is applied to contact surfaces 70, which would otherwise stand in direct contact with the polymerizable material. In this way, it is prevented that the material accumulates and polymerizes.

FIG. 7 shows schematically an installation for production of acrylic acid which comprises a first gas phase oxidation reactor 76 for oxidation of propylene to acrolein, which is connected to a further gas phase oxidation reactor 77, in which the acrolein is subjected to a further oxidation to acrylic acid. The acrylic acid gas mixture thus obtained in the further reactor 77 is fed to a quench device 78, to which is connected indirectly or directly a column 1 according to the invention. At the column according to the invention, one or more further purification units 79 can be connected. Among these can be, for example, crystallization devices such as layer crystallizers, suspension crystallizers which are connected to wash columns, or extractors or azeotropic distillers. The purification unit 79 can be arranged at a part of column I at which the acrylic acid collects with the greatest purity, whereby it is in one aspect the column head 80. By means of this design of device for production of acrylic acid, this is obtained in very high purity, mostly above about 99.8%. Comparable device designs are likewise conceivable for other polymerizable materials other than acrylic acid.

FIG. 8 shows schematically the construction of an experimental arrangement for determination of this density distribution of the vapor or gaseous state. Container 2 and first separating tray 23 are shown with dashed line. With a section 85, below the separating tray 23 an imaginary level 81 is depicted in which the determination of the isotropic density distribution in the vapor or gaseous state is carried out. The level 81 is, in the example depicted, free from other components of container 2 or components arranged therein. On opposite-lying regions of the level 81 are provided a source 82 for a radioactive radiation as well as a corresponding detector 83 for determination of the amount of impinging radioactive radiation. The source 82 sends a beam through the central point 87 of level 81 which substantially corresponds to the cross-section of container 2. Furthermore, a further position of the source and of the detector is depicted with a dashed line and identified with (II). The positions (I) and (II) are taken temporally one after the other and offset with respect to each other with a direction change 86, whereby respectively a measurement process has been carried out. In this process, the detector 83 has respectively counted the impinging impulse radiation.

The measurement result is shown schematically in FIG. 8 by means of two bar-type graphs. The measurement was carried out over a pre-determined time-period and with a certain beam width 88. The detector 83 has generated respectively a graph which shows the distribution of the count impulses (n) over the beam width 88. The maximum values of the first measurement (position I) and of the second measurement (position II) are indicated in the diagram with n_{I} and n_{II}. The integral of the count impulses (n) over the beam width 88 is indicated with A_{I} or A_{II}, respectively. The value or the form respectively of the respective integral or of the value of the count impulse is characteristic for the density of the medium through which the beam has passed or for the vapor or gaseous state through which the beam has passed. A bar-type form of the integrals or a high value of the count impulse shows that a very large proportion of the radiation emitted from source 82 has reached detector 83. Conversely, a very low value of the count impulse or a sharp form of the graph indicates a denser medium through which at least part of the radioactive radiation did not pass.

If a measurement of this type is carried out at more than one position (I, II, . . . ) with a previously described device, in particular with an inventive device, a maximum deviation of the isotropic density within the level 81 between inlet 4 and the first separating tray 23 is at most about 15%. For the depicted embodiment example, this means that the value of n_{I} is at least about 70% of n_{II}. Because the number of detected impulses is characteristic for the density of the vapor or gaseous state through which the beam has passed, the parameter can be used as a measure for the density. Accordingly, in this way, it can be established that an isotropic density distribution according to the invention is present.

FIG. 9 shows schematically a detail of a particular form of an undulating or wave-form tray plate 29 of a separating tray 23. Such a tray plate 29, in particular with the following properties, has a plurality of holes 30 and is particularly advantageous, in combination with the here-described embodiment variants but also independent therefrom. The advantage of an undulating or wave-form tray plate 29 is that at the lower side the adhering liquid drops 26 run down to the wave troughs 90 and mingle locally with each other there. This further reduces the danger of polymerization. At the same time, this accumulation of liquid leads to this also finally detaching. With a wave form of this tray plate 29, attachment 31, as, for example, shown in FIGS. 2 and 3, can be dispensed with, since the wave form itself provides a sort of separation, which hinders an undesired flowing back and forth of the liquid. In one aspect, more than one or even all separating trays 23 of a column 1 are equipped with such undulating or wave-form tray plates 29. In this aspect, tray plates 23 positioned adjacent to each other are arranged offset to each other with respect to the positioning and/or orientation of the wave form, in particular in the form that the wave peaks 89 or wave troughs 90 respectively of tray plates 29 form an angle of about 90°.

In another aspect, the form of the tray plate 29 is with a wave height 92 in the range from about 0.5 to about 5.0 cm, such as in a range from about 1.2 to about 1.7 cm. With wave height 92, in this context, is meant the average vertical distance of a wave peak 89 and a wave trough 90 to each other. A wave peak 89 lies here at a horizontal separation from its adjacent wave trough 90 (corresponds to the wave length 91) of about 3.0 cm to about 10 cm, in particular the wave length 91 lies in a range from about 4.0 cm to about 6.0 cm.

A further improvement in respect of the reduction of the tendency to polymerize can be achieved by means of special forms of surfaces of column 1 which come into contact with the polymerizable material. This is particularly the case for at least a part of the separating tray 23, of the flow distributor 20, of the inlet 4, of the flow rectifier 64 or of the container 2.

According to a variant, at least one of the above-mentioned surfaces or its coating respectively is at least partially provided with a particularly low average roughness value (Rₐ). The average roughness value is the arithmetic average (over a reference path 95) of the absolute amounts of the distances 96 of the actual profile 94 from the central position 93. Here, the average roughness value lies in a range less than about 2.0 μm (micrometer) in one aspect, in particular in a range from about 0.5 μm to about 1.0 μm. With such an average roughness value, the tendency of the liquid to adhere relative to the surface wetted by it is reduced, so that this liquid runs away or drops away more quickly. In FIG. 9, such an average roughness value is depicted as an example and illustration with reference to the surface of the tray plate 29.

In addition, the possibility also exists (alternatively or cumulatively) to provide at least one of the above-mentioned areas at least partially with a so-called self-cleaning surface and/or coating. In one aspect, this self-cleaning surface has an artificial, at least partially hydrophobic surface structure of raised parts and recesses, whereby the raised parts and recesses are formed by particles fixed on the surface by means of a carrier. This is advantageously distinguished in that the particles comprise a jagged structure with raised parts and/or recesses in the nanometer range (nanostructure 97 is shown schematically in FIG. 9). In one aspect, the raised parts comprise on average a height of about 20 to about 500 nm (nanometer), such as from about 50 to about 200 nm. The separation of the raised parts or recesses respectively on the particles in one aspect amounts to less than about 500 nm, such as less than about 200 nm. The jagged structure with raised parts and/or recesses in the nanometer range can be formed, e.g. by means of hollow spaces, pores, scores, peaks and/or spikes. The particles themselves have an average size of less than about 50 μm (micrometer), in another aspect less than about 30 μm, and in yet another aspect less than about 20 μm. In one aspect, the particles comprise a BET-surface area from about 50 to about 600 m²/g (square meter per gram). In another aspect, the particles comprise a BET-surface area from about 50 to about 200 m²/g. The so-called “BET-surface area” refers to the determination of this specific surface area by the well known process of BRUNAUER, EMMET and TELLER.

As structure-forming particles, diverse compounds from many branches of chemistry can be used, such as inorganic particles. In one aspect of the invention, the particles comprise at least one material selected from silicates, doped silicates, minerals, metal oxides, silicic acids, polymers and metal powders coated with silicic acid. In another aspect, the particles comprise pyrogenic silicic acid or precipitation silicic acids, in particular aerosils, Al₂O₃, SiO₂, TiO₂, ZrO₂, zinc powder jacketed with aerosol R974, in one aspect with the particle size of about 1 μm (micrometer) or powdery polymers, such as, for example, cryogenic, milled or spray-dried polytetrafluoroethylene (PTFE) or perfluorinated copolymers or respectively copolymers with tetrafluoroethylene. Particles of these types and coatings for generation of self-cleaning surfaces can be obtained, for example, from DEGUSSA A G.

Measurement Methods

The isotropic density (“direction-independent” density distribution) of the vapor or gaseous state and the deviation respectively are determined, for example, with a process of the company Ingenieurbüro Bulander & Esper GmbH in Zwingenberg, Germany. By means of a radioactive source, a directed beam (with a pre-determined width, e.g. 5 cm) is sent towards a detector. Source and detector are located on opposite sides of the column so that the beam extends substantially horizontally through the column. As source are used, for example, cobalt (Co 60) and caesium (Cs 137) with an activity of about 0.3 to about 3.7 GBq.

The beam emitted during the operation of the column is measured advantageously with a scintillation detector in the form of impulses per unit time and forwarded to an analysis or display device. In principal, a plurality of detectors and/or sources can also be provided, which are optionally arranged distributed around the circumference of the column. This latter arrangement has the advantage that for comparison measurements in different directions the same experimental construction can be retained and simply other sources and/or detectors come into use, so that measurement imprecisions as a result of incorrect mounting can be avoided.

Concerning the construction of the experimental arrangement, reference is further made to the details concerning FIG. 8.

While a radioactive beam of this type is emitted for a pre-determined time period through the vapor or gaseous state, a counter of the detector recognizes the impinging radiation and counts the impulses. The number of impulses per unit time is a measure of the density of the material located between source and detector. A high value characterizes a low density, since a large proportion of the emitted radiation has reached the detector. Accordingly, a low value of the counted impulses is characteristic for a higher density.

A uniform flow of the vapor or gaseous state can be recognized, for example, in that in a cross section the liquid and gaseous components are uniformly distributed. By this it can be recognized that the separating trays are locally blocked (so that, there, only a small proportion of liquid is present in the vapor or gaseous state and thus a lower density) or, for example, regions with reduced gas flows are present (where, because of the reduced counter-pressure, an increased liquid flow and thus an increased density can be observed).

To determine the isotropy, it is now proposed, first to undertake a measurement in a first direction in a level below the first operating tray and to acquire the detected radiation over a given time period (t; e.g. 5 min) (n). In order to reduce the influence of operational variations of the column, this measurement can also be carried out plural times, whereby a value (nᵢ) is recorded over the time period (t). An average value (N) is then formed and used as reference for the isotropy. It should here be further mentioned that the radioactive beam is emitted with a certain width (e.g. 5 cm) and the detector optionally has a resolution which enables a differentiation of the measured values over this width. Then, in turn, the average value or the area under the graphs (the integral) can be taken as reference, which represents the impulse rates over the width.

After a characteristic value or characteristic integral for the detected radiation has been recorded, the above-described procedure is repeated on the same level but in a direction deviating therefrom. The two directions enclose an angle which is in one aspect greater than about 30°, and in another aspect even greater than about 40°. In this way, at least two such measurements from different directions should be carried out, in particular even at least three.

In principal, a direction along the diameter of the column should be selected, in order to ensure that the free radiation length through the vapor or gaseous state is equally long and that accordingly the values for the detected radiation can be compared with each other. This is then possible because the radiation has passed through the same volume of the vapor or gaseous state. It is, naturally, also possible, to select a radiation path deviating herefrom, it should simply be ensured that this has the same length for each measurement.

The level can, in principal, be arranged in any way in the column and in one aspect is substantially parallel to at least one separating tray. In order to check the uniformity of the flow, such directional radiations through a separating tray, the distillate or through the vapor or gaseous state can be undertaken. In order to characterise the flowing towards behavior of the first separating tray, the level should in one aspect be selected in a region less than about 200 mm below the first separating tray. In particular, the level lies in a region from about 100 mm to about 10 mm below the first separating tray.

An isotropy of the density is present in the meaning of the invention, in particular, then, if the deviation of the recorded measured values (n and/or N) is at most about 15%. For determination of the deviation, an arithmetic average (M) of the measured value is determined. It is defined for a given number of direction measurements (X) as quotient from the sum of the measured values per direction (n_{X} and/or N_{X}) and the number of measured values (X). With a maximum deviation of, for example, about 5%, it is meant that the highest measured value of the impulse rate and the lowest measured value lie in a range from about 0.95 M to about 1.05 M. With the deviation given here, the measurement deviation as the result of cosmic environmental radiation (around ±50 count impulses for generally about 3 seconds measurement duration and a measurement band of about 50 mm) can be already taken into account.

FIG. 10 shows, schematically and in perspective, a further embodiment of the inlet 4 with a flow mixer 98 as a particular form of a flow influencer. The depicted inlet 4 comprises a bend 99, in which the polymerizable material is deflected. If the polymerizable material would, without a flow influencer, flow freely through such an inlet 4, the bend 99 would cause a non-uniform speed distribution of the flow over the cross-section of the inlet 4. The reason for this is flow turbulence and backflows in the region of the bend 99. In order to prevent this, it is also possible to provide a flow mixer 98 upstream in the proximity (such as directly before) bend 99. Such a flow mixer 98 divides the polymerizable material flowing towards it into more than one filament 100 and deflects these such that they follow substantially the same path through the bend 99. The polymerizable material in this aspect can be at least partially set in rotation. Thereby, a unified flow can be generated without pulsations and back-mixings, so that the cross-section of the inlet 4 is uniformly flowed across, also after bend 99, and the polymerizable material impinges, for example, on the flow distributor 20 uniformly distributed. It should further be mentioned that the provision of such a flow influencer and/or flow mixer 98 can occur at more than one bend 99 of inlet 4.

FIG. 11 illustrates a partial section of a container 2 with a spray unit 101 in cross-section, whereby in FIG. 12 a top view of the spray unit 101 shown in FIG. 11 is shown. Container 2 has a separating tray 23, whose lower side 105 (in particular during operation of the column 1) is cleaned with a spray unit 101. Such a spray unit 101 is in one aspect provided at least for the lowest separating tray 23 of container 2, if this comprises a plurality of separating trays 23 arranged one above the other. Through this separating tray 23 flows a liquid of the polymerizable material with a certain composition, which is then collected, for example, in a collecting reservoir 24 of container 2. Advantageously, it is now proposed to make this liquid available, via a supply device 104 of the spray unit 101 and thus to clean the lower side 105 of separating tray 23. The use of this liquid has the advantages that no significant influence of the distillation in the lowest separating tray 23 takes place. With this spray unit 101, components of the polymerizable material (optionally already partially polymerized) adhering to the lower side 105 of the separating tray 23 are effectively removed.

The spray unit 101 itself can comprise a plurality of nozzles 102. These are designed such that a substantially uniform cleaning of the separating tray 23 over its entire cross-section can occur. In this case, the arrangement and/or the type of the nozzles can be accordingly selected. FIG. 12 shows schematically a possible embodiment of the spray unit 101 with uniformly distributed nozzle 102, which comprise a substantially uniform spray area 103. Such a design of the spray unit 101 is technically and economically simple, but not absolutely necessary. The nozzles 102 are arranged here such that the spray regions 103 substantially do not overlap, this is, however, also not compulsory. As nozzles 102, both simple openings in the spray unit 101 as well as separate nozzle components come into consideration.

### LIST OF REFERENCE NUMERALS

1 column

2 container

3 connection

4 inlet

5 inner region

6 outer area

7 partial section

8 lower floor

9 partial area

10 jacket

11 layer

12 inner area

13 entry orifice

14 exit orifice

15 flow influencer

16 baffle

17 channel

18 section

19 central axis

20 flow distributor

21 tip

22 coating

23 separating tray

24 collecting reservoir

25 flow direction

26 drop

27 heater

28 pump

29 tray plate

30 opening

31 attachment

32 group

33 aperture

34 height

35 bar

36 length

37 rod or bar

38 spacer

39 breadth

40 sector

41 cover plate

42 separation

43 holder

44 carrier

45 side

46 dimension

47 recess

48 extension

49 foot

50 dimension

51 distance

52 width

53 projection

54 arrow

55 gravity

56 liquid layer

57 vapor bubble layer

58 droplet layer

59 bubble

60 liquid

61 baffle

62 central axis

63 tear edge

64 flow rectifier

65 connecting element

66 jacket area

67 grating structure

68 honeycomb structure

69 hole plate

70 contact area

71 layer density

72 surface roughness

73 porosity

74 distance

75 liquid level

76 first gas phase oxidation reactor

77 further gas phase oxidation reactor

78 quench unit

79 purification unit

80 column head

81 level

82 source

83 detector

84 path

85 section

86 direction change

87 central point

88 beam width

89 wave peak

90 wave trough

91 wave length

92 wave height

93 central position

94 actual profile

95 reference path

96 distance

97 nanostructure

98 flow mixer

99 bend

100 flow filament

101 spray unit

102 nozzle

103 spray region

104 supply device

105 lower side

1. A separating tray for a column for distillation of a polymerizable material comprising:
at least one tray plate with a plurality of openings; and
at least one attachment that divides the plurality of openings into groups and includes apertures through which a liquid can flow.

2. The separating tray according to claim 1, wherein the apertures extend from the tray plate to a height from about 1 mm to about 100 mm.

3. The separating tray according to claim 1, wherein the at least one attachment comprises at least one straight bar.

4. The separating tray according to claim 3, wherein the separating tray comprises at least one of the following configurations:
(a) more than one attachment provided with a bar; or
(b) one attachment provided with more than one bar; or
(c) one attachment provided with more than one bar, wherein the bars are joined together with each other.

5. The separating tray according to claim 4, wherein the at least one bar has a length and the plurality of openings is at least partially limited by at least one of the following elements:
(a) at least one rod that is part of the bar; or
(b) at least one spacer that is a separate part,
wherein the sum of the widths of the elements is smaller than 80% of the length of the bar.

6. The separating tray according to claim 1, wherein the at least one attachment forms sectors of the tray plate with a group of openings, wherein the sectors comprise an area in the range from about 0.3 m² to about 1.2 m².

7. The separating tray according to claim 1, further comprising a cover plate arranged at a separation of about 60 mm to about 200 mm from the tray plate.

8. The separating tray according to claim 1, further comprising a holder comprising at least one carrier in communication with the side of the tray plate facing away from the at least one attachment by a dimension in the range from about 200 mm to about 1000 mm.

9. The separating tray according to claim 8, wherein the at least one carrier further comprising at least one recess with an extension, wherein the sum of the extensions lies at least in the range from about 80% to about 30% of the dimension.

10. The separating tray according to claim 9, wherein the at least one carrier is T-shaped and the at least one recess is arranged in the part of the carrier lying substantially perpendicular to the tray plate.

11. The separating tray according to claim 10, wherein the at least one T-shaped carrier has a foot arranged substantially parallel to the tray plate and with a dimension of about 50 mm to about 100 mm, whereby the at least one recess is arranged at a distance less than about 3 mm.

12. The separating tray according to claim 8, wherein the at least one carrier and the at least one attachment are arranged substantially perpendicular to each other.

13. The separating tray according to claim 1, wherein the separating tray is at least partially coated with a glide enhancing coating.

14. A process for purification of a polymerizable material, the process comprising:
introducing the polymerizable material as a liquid through an inlet into a column comprising at least one separating tray with a plurality of openings, at least one attachment that divides the plurality of openings into groups and includes apertures through which a liquid can flow, and an inner region; and
transferring the polymerizable material to a vapor in the inner region.

15. The process according to claim 14, wherein the vapor flows with an isotropic density against a first separating tray arranged above the inlet, wherein between the inlet and the first separating tray the maximum deviation about an average value of the isotropic density is at most about 15%.

16. The process according to claim 14, wherein the polymerizable material comprises (meth)acrylic acid.

17. The process according to claim 14, wherein there is a reduced pressure in the inner region.

18. The process according to claim 14, wherein the liquid is superheated.

19. A process for production of a polymerizable material, the process comprising:
synthesizing the polymerizable material from at least one reagent in a reactor;
introducing the polymerizable material as a liquid through an inlet into a column comprising at least one separating tray with a plurality of openings, at least one attachment that divides the plurality of openings into groups and includes apertures through which a liquid can flow, and an inner region; and
transferring the polymerizable material to a vapor in the inner region.

20. A use of a separating tray according to claim 1 for distillation of a polymerizable material.

21. A polymerizable material obtainable by a process according to claim 19.

22. A use of a polymerizable material according to claim 21 as starting material in formed masses, fibers, sheets, absorbent polymers, in polymers for leather and textile processing, in polymers for water treatment or in polymers for soap production.

23. A product comprising any one of formed masses, fibers, sheets, absorbent polymers, polymers for leather and textile processing, polymers for water treatment or polymers for soap production, at least partially based on a polymerizable material according to claim 21.
